(19) United States
(12) Patent Application Publication
(10) Pub. No.: US 2015/0025672 A1
(43) Pub. Date: Jan. 22, 2015

(54) SYSTEM AND METHOD FOR SELECTING CUTTING TOOLS

(71) Applicants: Pradeep Hemmanur, Bangalore (IN); Colin John Deem, Worcestershire (GB); David C. Minich, Willoughby, OH (US)

(72) Inventors: Pradeep Hemmanur, Bangalore (IN); Colin John Deem, Worcestershire (GB); David C. Minich, Willoughby, OH (US)

(73) Assignee: Kennametal Inc., Latrobe, PA (US)

(21) Appl. No.: 13/965,646

(22) Filed: Aug. 13, 2013

(30) Foreign Application Priority Data
Jul. 18, 2013 (IN) 3215/CHE/2013

(51) Int. Cl. G05B 19/18; G06F 17/50

(52) U.S. Cl. CPC G05B 19/182; G06F 17/50; G05B 2219/50253
USPC 700/160

(57) ABSTRACT

A method of identifying a plurality of cutting tools for machining a feature having defined attributes associated therewith in a workpiece. The method comprises: assigning a characteristic to each cutting tool; receiving an indication from a user of a specific feature to be machined and at least one associated attribute; selecting a cutting tool based upon the specific feature to be machined, the at least one associated attribute of the specific feature to be machined, and the characteristic previously assigned to the cutting tool; determining if the characteristic of the selected cutting tool requires the use of another cutting tool to form the specific feature; and selecting at least one other cutting tool based at least upon the characteristic of the selected cutting tool until all of the attributes of the feature to be machined are capable of being produced by a combination of all of the selected cutting tools.

### FIELD OF THE INVENTION

The present invention relates to a system and method for identifying and selecting multiple cutting tools for machining a feature in a workpiece in a particular metal working operation. More particularly, the present invention relates to a system and method for identifying and selecting multiple cutting tools and optionally the particular sequence in which the cutting tools are to be employed in machining a feature in a workpiece.

### BACKGROUND INFORMATION

There are a variety of metal working cutting tools for cutting or shaping a metal workpiece. For example, one cutting tool is a rotating cutting tool that is generally employed in shaping or cutting a metallic work piece material. Such rotating cutting tools are commonly employed in machining geometries or “features” ranging from generally planar surfaces to complex grooves, recesses, holes or curved surfaces. These rotating cutting tools include those where the tool body and the cutting edge are formed from a single solid body (typically carbide type hard material), or those where an indexable insert formed with one or more cutting edges is secured to the tool body with a bolt or wedge mechanism and the like, such that it may be freely fitted and removed.

It will be appreciated that in order to determine an appropriate cutting tool or cutting tools required for machining a particular feature or features in a workpiece, it is necessary for a user, such as a manufacturing engineer or the like, to understand the relationships between various cutting tools that may be required to machine the particular feature. Additionally, one or more of the cutting tools employed may be a cutting tool assembly formed from multiple components. In such case, the relationships between the tool holder, one or more cutting tools, and potentially one or more intermediary components must also be understood. In either case, the user must also have an understanding of the properties of the particular material or materials being machined as well as the particular geometry or geometries being machined in such material. With the large number of available cutting tools, cutting tool components and systems, machined geometries and varying cutting conditions, it is extremely difficult for a user to identify and configure the optimum cutting tools for machining a particular feature or features.

In the past, a user was required to search through and examine multiple catalogs supplied by various cutting tool manufacturers, or to search cutting tool databases, and to select a combination of cutting tools (and components thereof for cutting tool assemblies) with little or no information about the optimum operating parameters of each particular cutting tool (or component thereof). Such approach requires a considerable amount of time and labor and is particularly dependent on the experience and skill of the user and therefore may be unreliable and may only take into consideration a limited number of factors which may affect machining of the workpiece and efficiency of the machining operation.

Thus, it would be desirable to provide a selection system and method that enables a user to select a combination of cutting tools tailored to the user's specific equipment and particular machining operation that provides fast, accurate results independent of the skill level of the user.

### SUMMARY

As one aspect of the present invention a method of identifying a plurality of cutting tools for machining a feature in a workpiece, the feature having defined attributes associated therewith, is provided. The method comprises the steps of: assigning a characteristic to each cutting tool; receiving an indication from a user of a specific feature to be machined and at least one associated attribute thereof; selecting a cutting tool based upon the specific feature to be machined indicated by the user, the at least one associated attribute of the specific feature to be machined, and the characteristic previously assigned to the cutting tool; determining if the characteristic of the selected cutting tool requires the use of another cutting tool to form the specific feature; and selecting at least one other cutting tool based at least upon the characteristic of the selected cutting tool until all of the attributes of the feature to be machined are capable of being produced by a combination of all of the selected cutting tools.

The method may further comprise the step of providing an indication to the user of all of the selected cutting tools.

Receiving an indication from a user of a specific feature to be machined may comprise receiving an indication from a user that one or more of: a planar surface, a curved surface, a hole, a recess, a shoulder, or a cylinder is the specific feature to be machined.

Receiving an indication from a user of at least one associated attribute may comprise receiving an indication from a user of one or more of: a dimension, tolerance, surface finish or material characteristic associated with the specific feature.

Receiving an indication from a user of a specific feature to be machined and at least one associated attribute thereof may comprise receiving an electronic model of the specific feature and associated attributes.

Each of the selected cutting tools may be identified to the user in a sequence in which each of the selected cutting tools are to be employed in machining the feature.

Operating parameters for each of the selected cutting tools may be identified to the user along with each of the selected cutting tools.

Each of the cutting tools may be identified to the user in a listing of the selected cutting tools provided to the user via at least one of an electronic display or via a hard copy paper printout. The listing may further include one or more of: part numbers, pricing information or availability of each of the selected cutting tools. The listing may further include scale representations of each of the selected cutting tools.

As another aspect of the present invention, a system for employing the method described above is provided. The system comprises a processing device adapted to: assign the characteristic to each cutting tool; receive, via an input device, the indication from the user of the specific feature to be machined and the at least one associated attribute thereof; select a cutting tool based upon the specific feature to be machined, the at least one associated attribute of the specific feature to be machined, and the characteristic previously assigned to the cutting tool; determine if the characteristic of the selected cutting tool requires the use of another cutting tool to form the specific feature; and select at least one other cutting tool based upon the characteristic of the selected cutting tool until all of the attributes of the feature to be machined are capable of being produced by a combination of all of the selected cutting tools.

The processing device may be further adapted to provide, via an output device, an indication to the user of all of the selected cutting tools.

As yet another aspect of the present invention, a system for employing the method described above is provided. The system comprises: an input device; a processing device in communication with the input device; and an output device in communication with the processing device. The processing device is adapted to perform operations as previously described and receive inputs via the input device and provide outputs via the output device.

The input and output devices may comprise a single touchscreen device.

The above-discussed embodiments of the present invention will be described further hereinbelow. When the word “invention” or “embodiment of the invention” is used in this specification, the word “invention” or “embodiment of the invention” includes “inventions” or “embodiments of the invention”, that is the plural of “invention” or “embodiment of the invention”. By stating “invention” or “embodiment of the invention”, the Applicant does not in any way admit that the present application does not include more than one patentably and non-obviously distinct invention, and maintains that this application may include more than one patentably and non-obviously distinct invention. The Applicant hereby asserts that the disclosure of this application may include more than one invention, and, in the event that there is more than one invention, that these inventions may be patentable and non-obvious one with respect to the other.

### BRIEF DESCRIPTION OF THE DRAWINGS

While various embodiments of the invention are illustrated, the particular embodiments shown should not be construed to limit the claims wherein like numerals are used for like elements throughout. It is anticipated that various changes and modifications may be made without departing from the scope of the invention.

FIG. 1 is a flow chart showing an example method in accordance with an embodiment of the present invention.

FIG. 2 is an isometric cross-sectional view of an example feature to be machined in accordance with an embodiment of the present invention.

FIG. 3 is a flow chart showing an example method in accordance with another embodiment of the present invention.

FIGS. 4-7 are schematic diagrams of example cutting tools and characteristics associated therewith in accordance with embodiments of the present invention.

### DETAILED DESCRIPTION OF THE INVENTION

As used herein, the term “user” shall be used to refer to a person or persons who desire to identify and configure a plurality of cutting tools for use in machining a feature having particular characteristics.

As used herein, the term “characteristics” shall be used to refer to details of a cutting tool which may be associated with a particular cutting tool. Such characteristics may be unique to a particular tool or may be used in conjunction with more than one tool.

As used herein, the term “workpiece” shall be used to refer to an object on which one or more cutting operations are to be performed.

As used herein, the term “feature” shall be used to refer to a geometric shape to be machined in or on a workpiece. Examples of a “feature” include, without limitation, planar surfaces, curved surfaces, holes, recesses, shoulders, cylinders, and the like.

As used herein, the term “attributes of a feature” shall be used to refer to, for example, without limitation, one or more of the dimensions, tolerance, surface finish or any other quantifiable element of the feature. “Attributes of a feature” may also include the type of material to be machined (e.g., without limitation, AISI 4140) or particular material characteristics (e.g., without limitation, hardness).

As used herein, the term “number” shall be used to refer to any non-zero quantity (i.e., one or any integer greater than one).

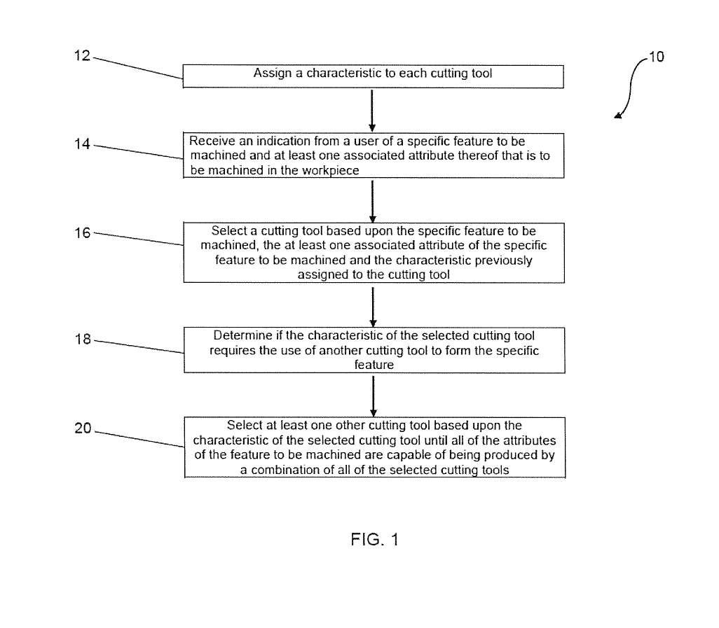

FIG. 1 is a flow chart providing a general overview of a method 10 in accordance with an example embodiment of the present invention. In general, the method 10 provides for the identification of a plurality of cutting tools for use in machining a feature in a workpiece. The cutting tools are identified through the simultaneous or nearly simultaneous execution of multiple rule sets by a suitable processing device which queries a database based on desired criteria or attributes of the feature to be machined which are received from a user. If a particular query identifies a cutting tool that suits the desired attributes received from the user, the cutting tool is then identified as a suitable tool for use in machining the particular feature. When a cutting tool is identified, characteristics associated with the cutting tool are considered by the processor to determine if a “pre-condition” is indicated which necessitates the use of another tool in addition to the one already identified. For example, a cutting tool for reaming (i.e., a “reamer”) would typically have a pre-condition indicative that a pre-formed hole having certain characteristics is required prior to a cutting operation using the reamer. As another example, a cutting tool for drilling (i.e., a “drill”) may have one or more pre-conditions indicating the need for a previously formed pilot hole or a particular angle of entry (i.e., the angle formed between the rotational axis of the cutting tool and the surface of the workpiece) in order to be utilized. If a pre-condition is determined to be present, the database is once again queried in order to find another suitable tool for use in machining the feature.

The cutting tools may be identified from a large assortment of cutting tools (e.g., an entire product line), from a smaller assortment of cutting tools (e.g., an in-stock inventory) or from any size assortment in between. Methods in accordance with the present invention offer a number of advantages over known methods such as previously described in the background section. Such advantages include, among others, that the time and expertise required in selecting the cutting tools is greatly reduced in comparison to previously known solutions. Embodiments of the present invention may be utilized by a user who knows the end product they intend to machine but are looking for guidance in regard to selecting the cutting tool(s) needed to machine the desired finished product.

It is to be appreciated that the methods described herein are generally applicable to being carried out through the use of a computing mechanism, such as, for example, without limitation, a desktop or laptop computer, a handheld computing device (e.g., tablet computer, smartphone) or any other suitable electronic processing device which is adapted to receive inputs via any suitable input device, produce outputs via any suitable output device, and perform processing operations on data stored in a database. In example embodiments of the invention such devices may be used to selectively access databases stored online (e.g., in an internet based “cloud” storage) or may rely on locally stored data. The data can be stored in data base format in any suitable electronic media, such as a memory storage device, microprocessor, controller, PLC, RAM, ROM, ASIC, CDROM, DVD, and the like.

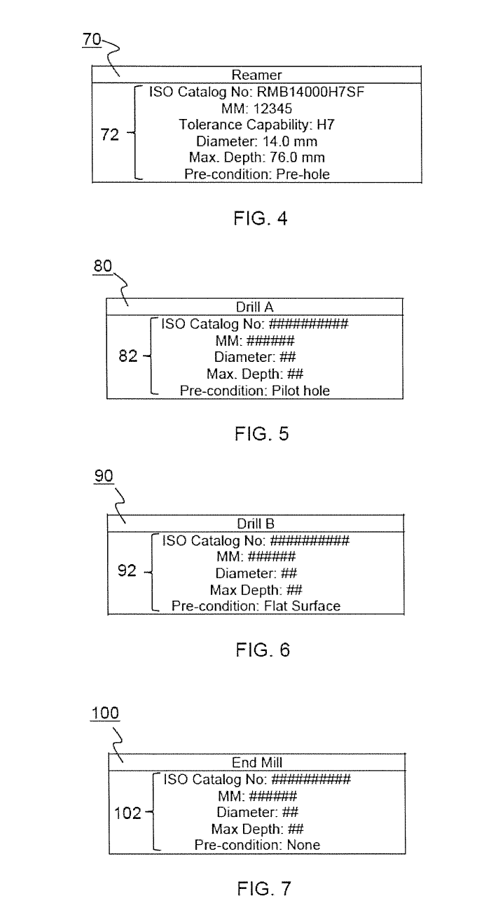

Referring to FIG. 1, the method 10 begins at step 12 where a characteristic or several characteristics are assigned or otherwise associated with each cutting tool contained in the electronic database. Such step may be carried out, for example, without limitation, when initially assembling a database, updating a database, or modifying a database. Non-limiting examples of individual cutting tools 70, 80, 90 and 100 that may be included in an example database in accordance with an embodiment of the present invention along with example characteristics 72, 82, 92 and 102 associated respectively therewith are illustrated schematically in FIGS. 4-7.

For example, the reamer 70 of FIG. 4 has a number of characteristics 72 associated therewith in the database. Such characteristics associated with each cutting tool may include, for example, without limitation, a catalog number (e.g., ISO Catalog No.), a unique internal reference number (e.g., MM: #), dimensional information (e.g., without limitation, tolerance, diameter, maximum depth of cut, reach, corner radius), details of a suitable material or materials the cutting tool may be capable of machining (e.g., type of material, hardness of material, etc.), and an indication of a required pre-condition. Such characteristics are provided in the database such that each cutting tool may be searched and identified based upon the particular (sometimes unique) characteristics associated therewith.

Continuing to refer to FIG. 1, method 10 continues at step 14 where an indication of a specific feature to be machined in a workpiece is received from a user along with at least one associated attribute of the feature. As briefly discussed above, such feature may include, for example, without limitation, planar surfaces, curved surfaces, holes, recesses, shoulders, cylinders, and the like, or combinations thereof. Such indications may be made, for example, without limitation, by a user: providing an input into a field or fields of an input screen, making a selection from a drop down menu, selecting a visual representation of the selection from among a number of visual representations, or providing an electronic model (e.g., a CADD model) containing the specific feature and associated attributes. It is to be appreciated, however, that any other suitable input arrangement may be employed without varying from the scope of the present invention.

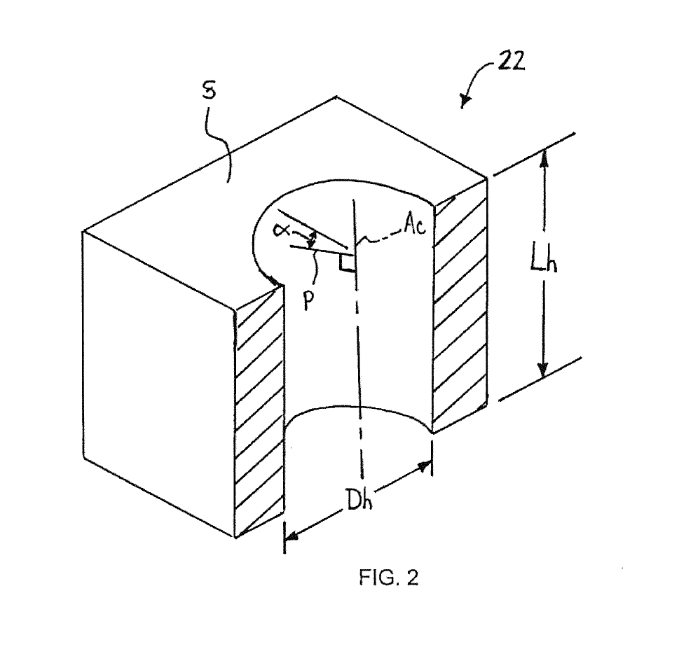

FIG. 2 illustrates an example of a visual representation 22 for a hole as provided in an example embodiment of the present invention. More particularly, the visual representation 22 is an isometric cross-sectional view of a hole feature and additionally provides indications Dh (hole diameter) and Lh (hole depth) of associated attributes in the form of dimensional information which is suggested and/or required to be additionally provided by the user as further inputs in order to provide an optimum cutting tool selection.

Next, as shown in step 16, the database of potential cutting tools is queried and a cutting tool is selected therefrom based upon the specific feature to be machined (as previously indicated by the user), the associated attribute or attributes of the specific feature (also previously indicated by the user), and the previously assigned characteristic or characteristics previously assigned and/or associated with the cutting tool.

As shown in step 18, after the cutting tool is selected in step 16, the characteristic(s) previously assigned thereto, are considered in order to determine if another cutting tool is required in addition to the selected cutting tool in order to form the specific feature previously identified by the user. More particularly, it is determined if there is a pre-condition associated with the selected cutting tool.

When it is determined that a pre-condition requiring another cutting tool is associated with the previously selected cutting tool, another cutting tool is then selected based at least upon the pre-condition characteristic of the previously selected cutting tool and relevant attributes of the specific feature to be machined as identified by the user, as shown in step 20. Additional cutting tools are thus selected in a similar manner until a cutting tool is selected that does not require any further cutting tools according to the pre-condition associated therewith or the lack thereof.

It is to be appreciated that such method is generally applicable to machining operations that may require any number of cutting tools in order to machine the specific desired feature.

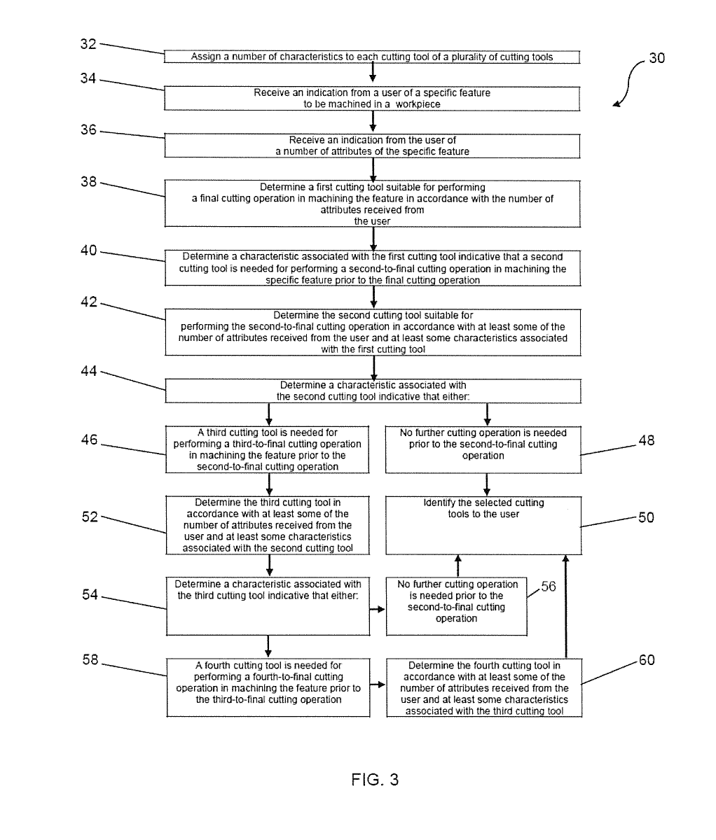

Having thus described a general overview of a method in accordance with the present invention, a more detailed example method 30 in accordance with the present invention will now be described in conjunction with FIG. 3.

Referring to FIG. 3, method 30 begins similar to step 12 of method 10 with step 32 wherein a number of characteristics, such as those previously described, are assigned to each cutting tool of a plurality of cutting tools in a database populated with cutting tools. The cutting tools included in such database may be varied depending on the needs or wants of the user or the operator of the system providing the method. For example, without limitation, if the operator of the system is a cutting tool supplier, it would likely be advantageous to include the supplier's entire catalog of cutting tools in the database so that the user (i.e., a consumer of cutting tools) would potentially be exposed to the entire catalog for potential purchases. As another non-limiting example, if the operator of the system is also a consumer of the cutting tools selected, it may be desirable to selectively include cutting tools which are present in inventory or otherwise readily available in order to ensure that tooling solutions provided could be implemented in a short timeframe or at a low cost due to the reduced and/or eliminated need to purchase cutting tools.

After the database has been populated as described in step 32, an indication of a specific feature to be machined in a workpiece is received from a user. In this example, we will presume the user has indicated a hole feature such as illustrated in FIG. 2 as the specific feature to be machined in the workpiece. Next, a number of attributes of the specific feature are received from the user, as shown in step 36. In this example, after indicating that a hole is the desired feature to be machined, the user then proceeded to provide a desired hole diameter Dh of 14.0 mm, hole depth Lh of 45.0 mm, a desired tolerance of H7, the workpiece material being a stainless steel, and an inclination angle α of 25° for the surface S of the workpiece with respect to a reference P disposed perpendicular to the central axis Ac of the workpiece (see FIG. 2).

Proceeding to step 38, after receiving the indications that a hole having the particular attributes previously discussed is the specific feature to be machined in a workpiece, a first cutting tool suitable for performing a final cutting operation in machining the specific feature in accordance with the attributes provided by the user is determined by querying the database. In this example, a reamer 70 such as shown schematically in FIG. 4 was determined to fit the particular criteria of the query and thus selected as a cutting tool for forming the specific feature.

Next, a characteristic associated with the first cutting tool (i.e., reamer 70) indicative that a second cutting tool is needed for performing a second-to-final cutting operation, prior to the final cutting operation, in machining the specific feature (i.e., a hole) is determined, as shown in step 40. In this example, the characteristic “Pre-condition: Pre-hole” of reamer 70 provides an indication that a hole must be drilled in the workpiece prior to using the reamer 70. Accordingly, a second cutting tool suitable for performing such a second-to-final cutting operation in accordance with at least some of the number of attributes received from the user and at least some of the characteristics associated with the first cutting tool (i.e., reamer 70) is determined by once again querying the database, as shown in step 42. In this example, drill A 80, as shown schematically in FIG. 5, was determined to fit the particular criteria of the query and thus selected as a cutting tool for forming the specific feature.

Next, similar to step 40 previously discussed, in step 44 a determination is made whether a characteristic associated with the second cutting tool is indicative that either: an additional cutting tool (i.e., a third cutting tool) is needed for performing a third-to-final cutting operation, prior to the second-to-final cutting operation, in machining the specific feature is needed, as shown in step 46; or that no further cutting operation is needed prior to the second-to-final cutting operation, as shown in step 48. If the latter determination is made, the selected cutting tools, i.e., the first cutting tool and the second cutting tool, are identified (as discussed further below) to the user as the cutting tools needed to machine the specific feature in accordance with the specified attributes, such as shown in step 50.

In the present example, as the second cutting tool (i.e., Drill A 80) had the characteristic “Pre-condition: Pilot hole” indicating that a pilot hole is needed prior to using Drill A 80, the method proceeds instead to step 52 wherein a third cutting tool is determined by querying the database in accordance with at least some of the number of attributes received from the user and at least some of the characteristics associated with the second cutting tool. In this example, Drill B 90, shown schematically in FIG. 6 was determined to be the appropriate third cutting tool based on the attributes and characteristics included in the query and thus selected as a cutting tool for forming the specific feature.

Once again, similar to steps 40 and 44, previously discussed, a determination is made whether a characteristic associated with the third cutting tool is indicative that either: an additional cutting tool (i.e., a fourth cutting tool) is needed for performing a fourth-to-final cutting operation, prior to the third-to-final cutting operation, in machining the specific feature is needed, as shown in step 58; or that no further cutting operation is needed prior to the third-to-final cutting operation, as shown in step 56. If the latter determination is made, the selected cutting tools, i.e., the first cutting tool, the second cutting tool and the third cutting tool, are identified (as discussed further below) to the user as the cutting tools needed to machine the specific feature in accordance with the specified attributes, such as shown in step 50.

In the present example, as the third cutting tool (i.e., Drill B 90) had the characteristic “Pre-condition: Flat Surface” indicating that an angle of entry α of 90° is needed for using Drill B 90, the method proceeds instead to step 60 wherein a fourth cutting tool is determined by once again querying the database in accordance with at least some of the number of attributes received from the user and at least some of the characteristics associated with the third cutting tool. In this example, End Mill 100, shown schematically in FIG. 7 was determined to be the appropriate third cutting tool based on the attributes and characteristics included in the query and thus selected as a cutting tool for forming the specific feature. As the End Mill 100 does not contain any characteristic indicative that another cutting tool is needed (i.e., “Pre-condition: None”) the method 30 thus concludes by identifying the selected cutting tools (i.e., Reamer 70, Drill A 80, Drill B 90, and End Mill 100) to the user, as indicated in step 50. It is to be appreciated, however, that if the characteristics 102 associated with End Mill 100 included an indication that a further cutting tool was needed, the method 30 would continue until a selected cutting tool no longer included a characteristic indicating that another cutting tool was needed.

It is to be appreciated that step 50 wherein the selected cutting tools are identified to the user may be accomplished in a multitude of ways without varying from the scope of the present invention. For example, without limitation, the selected cutting tools be identified to the user as a listing of the cutting tools and optionally particular details thereof (e.g., without limitation, part numbers, pricing information, availability, etc.) to assist the user in obtaining such cutting tools. Such listing may be provided on an output device (e.g., a display screen), via a hard copy paper printout or via any other suitable delivery method known in the art. In various embodiments of the present invention, the identification of the selected cutting tools includes scale representations of each of the selected cutting tools. Such representations may be provided as a visual for the user to confirm the components and/or assembly appear(s) as intended and/or as an electronic model which may be subsequently used by the user in programming the machine tool(s) for which the cutting tools are intended to be used. Additionally, parameters of the overall cutting operation (e.g., without limitation, order of use) and well as operating parameters for the individual cutting tools (e.g., without limitation, speed, feed rate) may also be provided to the user.

It will be appreciated that the methods of the invention are not limited by the number of cutting tools which may be needed in order to machine a particular feature in a workpiece and that the invention can be practiced with any desired number of cutting tools or features. It will also be appreciated that the methods of the invention may also be applied to cutting tools formed from multiple components (i.e., cutting tool assemblies). It will also be further appreciated that, dependent on the number of potential cutting tools or potential cutting tool assemblies included in the database from which suitable cutting tools may be identified, the number of potentially suitable cutting tools and sequences thereof identified may be more than one. In such case, all of the cutting tools and corresponding sequences thereof identified may be provided to the user as a listing or other suitable output. Such listing may be ordered in accordance with a preset ranking system based upon ready availability in inventory, metal removal rate, a ranking selected by the user (e.g., cost) or any other suitable ranking system.

The purpose of the statements about the object or objects is generally to enable the Patent and Trademark Office and the public to determine quickly, from a cursory inspection, the nature of this patent application. The description of the object or objects is believed, at the time of the filing of this patent application, to adequately describe the object or objects of this patent application. However, the description of the object or objects may not be completely applicable to the claims as originally filed in this patent application, as amended during prosecution of this patent application, and as ultimately allowed in any patent issuing from this patent application. Therefore, any statements made relating to the object or objects are not intended to limit the claims in any manner and should not be interpreted as limiting the claims in any manner.

The summary is believed, at the time of the filing of this patent application, to adequately summarize this patent application. However, portions or all of the information contained in the summary may not be completely applicable to the claims as originally filed in this patent application, as amended during prosecution of this patent application, and as ultimately allowed in any patent issuing from this patent application. Therefore, any statements made relating to the summary are not intended to limit the claims in any manner and should not be interpreted as limiting the claims in any manner.

The description of the embodiment or embodiments is believed, at the time of the filing of this patent application, to adequately describe the embodiment or embodiments of this patent application. However, portions of the description of the embodiment or embodiments may not be completely applicable to the claims as originally filed in this patent application, as amended during prosecution of this patent application, and as ultimately allowed in any patent issuing from this patent application. Therefore, any statements made relating to the embodiment or embodiments are not intended to limit the claims in any manner and should not be interpreted as limiting the claims in any manner.

The purpose of the title of this patent application is generally to enable the Patent and Trademark Office and the public to determine quickly, from a cursory inspection, the nature of this patent application. The title is believed, at the time of the filing of this patent application, to adequately reflect the general nature of this patent application. However, the title may not be completely applicable to the technical field, the object or objects, the summary, the description of the embodiment or embodiments, and the claims as originally filed in this patent application, as amended during prosecution of this patent application, and as ultimately allowed in any patent issuing from this patent application. Therefore, the title is not intended to limit the claims in any manner and should not be interpreted as limiting the claims in any manner.

We claim:

1. A method of identifying a plurality of cutting tools for machining a feature in a workpiece, the feature having defined attributes associated therewith, the method comprising the steps of:
assigning a characteristic to each cutting tool;
receiving an indication from a user of a specific feature to be machined and at least one associated attribute thereof;
selecting a cutting tool based upon the specific feature to be machined indicated by the user, the at least one associated attribute of the specific feature to be machined, and the characteristic previously assigned to the cutting tool;
determining if the characteristic of the selected cutting tool requires the use of another cutting tool to form the specific feature; and
selecting at least one other cutting tool based at least upon the characteristic of the selected cutting tool until all of the attributes of the feature to be machined are capable of being produced by a combination of all of the selected cutting tools.

2. The method of claim 1 further comprising the step of providing an indication to the user of all of the selected cutting tools.

3. The method of claim 1 wherein receiving an indication from a user of a specific feature to be machined comprises receiving an indication from a user that one or more of: a planar surface, a curved surface, a hole, a recess, a shoulder, or a cylinder is the specific feature to be machined.

4. The method of claim 1 wherein receiving an indication from a user of at least one associated attribute comprises receiving an indication from a user of one or more of a: dimension, tolerance, surface finish or material characteristic associated with the specific feature.

5. The method of claim 1 wherein receiving an indication from a user of a specific feature to be machined and at least one associated attribute thereof comprises receiving an electronic model of the specific feature and associated attributes.

6. The method of claim 2 wherein each of the selected cutting tools are identified to the user in a sequence in which each of the selected cutting tools are to be employed in machining the feature.

7. The method of claim 6 wherein operating parameters for each of the selected cutting tools are identified to the user along with each of the selected cutting tools.

8. The method of claim 1 wherein each of the cutting tools are identified to the user in a listing of the selected cutting tools provided to the user via at least one of an electronic display or via a hard copy paper printout.

9. The method of claim 8 wherein the listing further includes one or more of: part numbers, pricing information or availability of each of the selected cutting tools.

10. The method of claim 8 wherein the listing further includes scale representations of each of the selected cutting tools.

11. A system for employing the method as recited in claim 1, the system comprising:
a processing device adapted to:
assign the characteristic to each cutting tool;
receive, via an input device, the indication from the user of the specific feature to be machined and the at least one associated attribute thereof;
select a cutting tool based upon the specific feature to be machined, the at least one associated attribute of the specific feature to be machined, and the characteristic previously assigned to the cutting tool;
determine if the characteristic of the selected cutting tool requires the use of another cutting tool to form the specific feature; and
select at least one other cutting tool based upon the characteristic of the selected cutting tool until all of the attributes of the feature to be machined are capable of being produced by a combination of all of the selected cutting tools.

12. The system of claim 11 wherein the processing device is further adapted to provide, via an output device, an indication to the user of all of the selected cutting tools.

13. A system for employing the method as recited in claim 1, the system comprising:
an input device;
a processing device in communication with the input device; and
an output device in communication with the processing device,
wherein the processing device is adapted to:
assign the characteristic to each cutting tool;
receive, via the input device, the indication from the user of the specific feature to be machined and the at least one associated attribute thereof;
selecting a cutting tool based upon the specific feature to be machined, the at least one associated attribute of the specific feature to be machined, and the characteristic previously assigned to the cutting tool;
determine if the characteristic of the selected cutting tool requires the use of another cutting tool to form the specific feature; and
select at least one other cutting tool based upon the characteristic of the selected cutting tool until all of the attributes of the feature to be machined are capable of being produced by a combination of all of the selected cutting tools.

14. The system of claim 13 wherein the processing device is further adapted to provide, via the output device, an indication to the user of all of the selected cutting tools.

15. The system of claim 13 wherein the input and output devices comprise a single touchscreen device.
